(19) United States
(12) Patent Application Publication
(10) Pub. No.: US 2017/0313789 A1
(43) Pub. Date: Nov. 2, 2017

(54) METHOD FOR SYNTHESIZING A POLYMER BEARING A HYDROXYARYL GROUP, PRODUCT DERIVED FROM THIS METHOD AND COMPOSITION CONTAINING SAME

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Claire RANNOUX, Lausanne (CH); Rachid MATMOUR, Clermont-Ferrand Cedex 9 (FR); Cédric LOUBAT, Castries (FR); Gilles BOUTEVIN, Castries (FR)

(21) Appl. No.: 15/521,878

(22) PCT Filed: Oct. 22, 2015
(86) PCT No.: PCT/EP2015/074512

§ 371 Date: Apr. 25, 2017

(30) Foreign Application Priority Data
Oct. 27, 2014 (FR) 1460290

(51) Int. Cl. C08C 19/40; C08K 3/00

(52) U.S. Cl. CPC C08C 19/40; C08K 3/0033

(57) ABSTRACT

The invention relates to a process for the synthesis of a polymer bearing one or more pendant hydroxyaryl groups comprising the reaction of a polymer bearing one or more pendant epoxide functional groups with a nucleophilic compound bearing the hydroxyaryl group.

This application is a 371 national phase entry of PCT/EP2015/074512, filed 22 Oct. 2015, which claims benefit of French Patent Application No. 1460290, filed 27 Oct. 2014, the entire contents of which are incorporated herein by reference for all purposes.

### BACKGROUND

### 1. Technical Field

The present invention relates to polymers, in particular elastomers, bearing at least one pendant hydroxyaryl group and to their process of preparation. The present invention also relates to rubber compositions containing such elastomers for the purpose in particular of an improvement in the dispersion of the fillers within the polymers.

### 2. Related Art

In the field of the manufacture of tires and in particular of the formulation of rubber compositions in contact with the ground, known as treads, there is a continual search for means for improving the dispersion of the fillers within the polymers and thus for improving the properties of reinforcement of the rubber composition containing them. One of the means for achieving this result is the use of coupling agents capable of establishing interactions between the polymer and the filler. Another means for achieving it is to use polymers, the structure of which is modified with the aim of obtaining a good interaction between the polymer thus modified and the filler, whether it is carbon black or a reinforcing inorganic filler.

The modification of the structure of the polymers can be carried out by introduction of a functional group which is reactive with regard to the filler, at any point in its synthesis by various known means. Thus, the functional group can be introduced into the structure of the polymer at the time of the initiation of an anionic polymerization, when the polymerization initiator bears this functional group. The functional group will be borne at the chain end on conclusion of the synthesis. The functional group can also be introduced at the chain end of a polymer by reaction of a living polymer with a functionalization agent. The functional group can also be borne by one of the polymerized monomers.

It is these modification approaches with which the authors of Applications WO2009/086490 A2 and WO2011/002994 A2 were concerned in order to introduce at least one hydroxyaryl group within a diene elastomer in order to improve the dispersibility of the reinforcing filler in an elastomer matrix.

This is because WO2009/086490 A2 describes a method for synthesizing polymers functionalized with at least one aryl group substituted by at least one OR functional group, R being hydrolysable. The substituted aryl group can be introduced during the initiation stage, during the anionic polymerization or during the termination (by choosing appropriate initiators, monomers or functionalization agents). WO2011/002994 A2 describes a method for synthesizing polymers bearing pendant hydroxyaryl groups. This method consists in copolymerizing, by the radical route, monomers comprising at least one comonomer bearing the protected hydroxyaryl group.

However, these synthesis methods make it possible to introduce only a single functional group into the structure of the polymer, when the functionalization is carried out at the initiation or the termination of the polymerization, unless coupling or star-branching agents or at least bifunctional initiators are used. This modification to the polymer in addition imposes the need to prepare beforehand polymerization initiators or functionalization agents, the hydroxyaryl groups of which are protected. This also results in an additional deprotection stage at the end of the synthesis process.

Furthermore, the methods of synthesis by copolymerization which make it possible to introduce several pendant hydroxyaryl groups resort to specific comonomers bearing the hydroxyaryl group. Here again, the synthesis of the functional polymer imposes the need to protect the hydroxyl functional groups of the hydroxyaryl groups of the comonomer. The protection of the hydroxyl functional groups of the comonomer adds a stage which will go hand-in-hand with another stage on conclusion of the synthesis process, that of deprotection of the same functional groups. Furthermore, the comonomers bearing a hydroxyaryl group are not readily available, indeed even unavailable.

In order to have a real benefit related to the reactivity of the hydroxyaryl groups of a polymer comprising them for the purpose of a significant modification to its reinforcing properties, it appears desirable to have several pendant hydroxyaryl groups.

Consequently, the technical problem which is posed with respect to the prior art is to provide a process which makes possible the synthesis of polymer, in particular diene polymer, bearing one or more pendant hydroxyaryl groups which overcomes the disadvantages of the earlier processes.

### SUMMARY

The present invention makes it possible to solve this problem by providing a process for the synthesis of a polymer bearing one or more hydroxyaryl groups, which process makes it possible to introduce, in a simple and controlled manner, one or more pendant hydroxyaryl groups, without resorting to comonomers bearing a hydroxyaryl group which have in particular the disadvantages of requiring additional stages of protection and deprotection of the hydroxyl functional group and which are not available or not readily available commercially.

Thus, a subject-matter of the invention is a process for the synthesis of a polymer bearing at least one pendant hydroxyaryl group, which process comprises the reaction of a starting polymer bearing at least one pendant epoxide functional group with a nucleophilic compound simultaneously bearing the hydroxyaryl group and bearing a nucleophilic functional group selected from the group consisting of the primary amine functional group, the secondary amine functional group, the carboxylic acid functional group and their ionic form.

Another subject-matter of the invention is the polymer, in particular elastomer, bearing at least one pendant hydroxyaryl group capable of being obtained by such a synthesis process.

Another subject-matter of the invention is a reinforced rubber composition based at least on a reinforcing filler and on the polymer, in particular elastomer, in accordance with the invention.

The invention also relates to a tire, one of the constituent elements of which comprises the rubber composition in accordance with the invention.

### DETAILED DESCRIPTION OF EXAMPLE EMBODIMENTS

In the present description, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

In the present description, “at least one group” is understood to mean one or more groups.

In the present description, “at least one functional group” is understood to mean one or more functional groups.

In the present description, the expression “hydroxyaryl group”, with reference to the group borne by the nucleophilic compound or by the polymer, is understood to mean an aryl group bearing at least one hydroxyl functional group directly bonded to a carbon of the benzene ring, the aryl group being or not being substituted on at least one other carbon of the benzene ring.

In the present description, the expression “pendant group” is understood according to the definition given by IUPAC, PAC, 1996, 68, 2287.

A subject-matter of the invention is thus a process for the synthesis of a polymer bearing at least one pendant hydroxyaryl group, which process comprises the reaction of a starting polymer bearing at least one pendant epoxide functional group with a nucleophilic compound bearing the hydroxyaryl group.

“Epoxide functional group” is understood to mean the 3-membered ring formed by one oxygen atom and two carbon atoms, it being possible for the carbon atoms of the ring to be substituted.

According to any one of the embodiments of the invention, the epoxide functional group is preferably represented by the following formula:

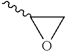

In the continuation of the disclosure of the invention, the designation “the epoxide functional group” is used to denote the at least one epoxide functional group, that is to say one or more epoxide functional groups.

In the continuation of the disclosure of the invention, the designation “the hydroxyaryl group” is used to denote the at least one hydroxyaryl group, that is to say one or more hydroxyaryl groups.

In the continuation of the disclosure of the invention, the designation “the starting polymer” denotes the polymer bearing the pendant epoxide functional group and of use for the requirements of the synthesis process in accordance with the invention.

According to any one of the embodiments of the invention, preferably the epoxide functional group is attached to the polymer chain elsewhere than at the end of the polymer chain.

According to any one of the embodiments of the invention, the starting polymer preferably bears several pendant epoxide functional groups.

According to any one of the embodiments of the invention, the starting polymer can be an elastomer, a liquid polymer or a thermoplastic polymer, whether block, alternating or random.

In the present patent application, liquid polymer is understood to mean a polymer which, at ambient temperature (23° C.), takes the shape of the container which contains it but the volume of which is predetermined.

An essential characteristic of the starting polymer of use for the requirements of the synthesis process in accordance with the invention is that it bears the pendant epoxide functional group. The introduction of pendant epoxide functional group into a polymer chain can be readily accessible in a synthesis stage. There exist two different synthesis principles. The epoxide functional group can be introduced by at least one of the constituent monomers of the polymer or else the epoxide functional group can be obtained by the postpolymerization modification of the polymer. Such polymers bearing the pendant epoxide functional group and the processes for obtaining them are well known to a person skilled in the art and some are commercially available.

According to a first alternative form of the invention, the starting polymer is a polymer of at least one first monomer bearing the epoxide functional group, preferably one epoxide functional group. It is clearly understood in the present invention that the first monomer can be a mixture of monomers bearing the epoxide functional group, preferably one epoxide functional group.

According to the first alternative form of the invention, the synthesis of the starting polymer is preferably carried out by radical copolymerization, according to conventional processes known to a person skilled in the art, such as emulsion, solution, suspension or bulk radical copolymerization.

The radical polymerization is carried out at temperatures varying from −10° C. to 200° C., preferably from 0 to 100° C., the temperature being chosen by a person skilled in the art taking into account in particular the reactivity of the polymerization medium and its concentration.

The polymerization initiator can be any conventional radical polymerization initiator, in particular, by way of example, an organic peroxide, such as benzoyl peroxide, lauroyl peroxide, tert-butyl hydroperoxide, cumyl hydroperoxide, para-menthyl hydroperoxide, di(tert-butyl) peroxide or dicumyl peroxide. Furthermore, the radical polymerization initiators can also include peracids and their esters, such as peracetic acid and potassium persulphate. Each radical polymerization initiator can be used alone or in combination with at least one other radical polymerization initiator.

Recourse may also be had, as radical polymerization, to controlled radical polymerization, which makes possible a high degree of control of the macrostructure and of the microstructure of the polymer. Controlled radical polymerization is known to a person skilled in the art and is described in numerous works. Controlled radical polymerizations include, for example, atom transfer radical polymerization (ATRP), nitroxide-mediated polymerization (NMP) or reversible addition-fragmentation chain-transfer (RAFT) polymerization.

In the reaction medium of radical polymerization, transfer agents, such as mercaptans, in particular tert-dodecyl mercaptan or n-dodecyl mercaptan, or such as carbon tetrachloride or also di- or triterpene, can also be used, alone or in combination.

For a radical polymerization carried out in emulsion, the surfactants employed in the emulsion polymerization can be anionic, cationic or nonionic, or amphoteric entities. They can be used alone or in combination.

For a radical polymerization carried out in suspension, the stabilizing agents employed in the suspension polymerization can, for example and nonexhaustively, be poly(vinyl alcohol), poly(sodium acrylate) or hydroxyethylcellulose.

For a radical polymerization, whether in solution, in suspension, in bulk or in emulsion, the monomers, the polymerization initiator and also the other constituents of the polymerization medium can be introduced into the reactor in a single charge at the start of the polymerization or continuously or sequentially throughout the polymerization.

The radical polymerization is carried out conventionally under an inert atmosphere, for example under nitrogen or under argon. The typical duration of the polymerization is between 15 min and 48 h, more commonly between 1 h and 24 h.

According to a specific embodiment of the first alternative form, the monomer units of the first monomer bearing the epoxide functional group are the only constituent monomer units of the starting polymer.

According to another embodiment of the first alternative form of the invention, the starting polymer is a polymer of at least one first monomer bearing the epoxide functional group and of at least one second monomer.

The second monomer can be a vinyl monomer chosen from ethylene, α-olefins, (meth)acrylonitrile, (meth)acrylates, vinyl esters of carboxylic acids, vinyl alcohol, vinyl ethers and the mixtures of these monomers.

Suitable as α-olefins are, for example, α-monoolefins, conjugated dienes and non-conjugated dienes.

Suitable as α-monoolefins are, for example, alkenes and vinylaromatic (vinylarene) compounds. Mention may be made, as alkenes, of those having from 3 to 12 carbon atoms, in particular propylene.

Mention may be made, as vinylaromatic compounds, of those having from 8 to 20 carbon atoms, such as, for example, styrene, ortho-, meta- or para-methylstyrene, para-(tert-butyl)styrene, α-methylstyrene, the “vinyltoluene” commercial mixture, vinylmesitylene, divinylbenzene or vinylnaphthalene.

Suitable as conjugated dienes are, for example, those having from 4 to 15 carbon atoms, such as, for example, 1,3-butadiene, 2-methyl-1,3-butadiene (isoprene), 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene or 1,3-pentadiene.

Suitable as non-conjugated dienes are, for example, those having from 5 to 12 carbon atoms, such as, in particular, 1,4-hexadiene, vinylnorbornene, ethylidenenorbornene, norbornadiene and dicyclopentadiene.

Suitable as (meth)acrylonitrile are acrylonitrile and methacrylonitrile.

Mention may be made, as (meth)acrylates, that is to say acrylates or methacrylates, of acrylic esters derived from acrylic acid or methacrylic acid with alcohols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate and isobutyl methacrylate.

Mention may be made, as vinyl esters of carboxylic acids, for example, of vinyl acetate and vinyl propionate, preferably vinyl acetate.

Suitable as vinyl ethers are, for example, those for which the R group of the ether functional group OR contains from 1 to 6 carbon atoms.

According to a preferred embodiment of the first alternative form of the invention, the second monomer is ethylene, 1,3-butadiene, isoprene, a mixture of butadiene and of isoprene or styrene.

According to a specific embodiment of the first alternative form of the invention, the starting polymer is a polymer of at least one first monomer bearing the epoxide functional group, of ethylene or of an α-olefin and of a third monomer. The third monomer is chosen from vinyl monomers as defined above, it being known that it is distinct from the second monomer. Preferably, the third monomer is a vinyl ester, in particular vinyl acetate, or an alkyl methacrylate, the alkyl having from 1 to 12 carbon atoms, or also a vinylaromatic compound, in particular styrene.

According to any one of the embodiments of the first alternative form of the invention, the first monomer bearing the epoxide functional group is preferably a monomer bearing an epoxide functional group, more preferably a glycidyl group, more preferably still a glycidyl ester of an α,β-unsaturated carboxylic acid, better still a glycidyl ester of methacrylic acid, acrylic acid or itaconic acid.

According to a particularly preferred embodiment of the first alternative form of the invention, the starting polymer is a terpolymer of ethylene or α-olefin, of vinyl acetate and of glycidyl (meth)acrylate or a terpolymer of ethylene or α-olefin, of an alkyl (meth)acrylate, the alkyl having from 1 to 17 carbon atoms, and of glycidyl (meth)acrylate. Very particularly suitable as terpolymer is the terpolymer of ethylene, of vinyl acetate and of glycidyl methacrylate, the synthesis of which is, for example, described in Patent Application WO 2013192159.

Mention may be made, as example of copolymers or terpolymers of use for the requirements of the synthesis process in accordance with the invention as starting polymer, for example, of the “Lotader” commercial terpolymers from Arkema, in particular “Lotader AX8840” and “Lotader AX8900”.

According to a second alternative form of the invention, the starting polymer is obtained by the postpolymerization modification of an unsaturated polymer by an epoxidized compound. Unsaturated polymer is understood to mean, in the present patent application, a polymer which comprises carbon-carbon double bonds. The principle of the modification of the unsaturated polymer rests on the reaction of the epoxidized compound with at least one carbon-carbon double bond of the unsaturated polymer. These epoxidized compounds comprise, besides the epoxide functional group, a group which is reactive with regard to a carbon-carbon double bond via a reaction known to a person skilled in the art.

Mention may be made, as known reaction, of the Diels-Alder reaction, it being possible for the epoxidized compound to be the diene or the dienophile. In the first case, where the epoxidized compound is the diene, the epoxidized compound can be a diene bearing an epoxide functional group. In the second case, where the dienophile epoxidized compound is a mono-olefin, the unsaturated polymer to be modified contains conjugated carbon-carbon double bonds. Polymers containing conjugated carbon-carbon double bonds can be obtained by the polymerization of triene monomers, in particular alloocimene, as is described, for example, in Application EP 2 423 239 A1.

Mention may also be made of the hydrosilylation reaction of a hydrosilane bearing an epoxide functional group, in particular (3-glycidoxypropyl)tetramethyldisiloxane, as is, for example, described in Patent Application FR 13/62946.

Mention may also be made of the radical grafting reaction of a thiol, the thiol bearing an epoxide functional group, as is described, for example, in the following publications: Angew. Chem. Int. Ed., 2010, 49, 1540-1573; J. Polym. Sci.: Part A: Polym. Chem., 2004, 42, 5301-5338; Polym. Chem., 2010, 1, 17-36; FR 12/62470.

The unsaturated polymer can have any microstructure. The unsaturated polymer can, for example, be a block, random, sequential or microsequential polymer and be prepared in dispersion, in emulsion or in solution; it can be coupled, star-branched or else functionalized with a coupling, star-branching or functionalization agent. The unsaturated polymer, in particular diene polymer, can be obtained according to conventional polymerization techniques (anionic polymerization, coordination catalytic polymerization, radical polymerization, and the like) well known to a person skilled in the art.

The unsaturated polymer according to the invention can be selected from the group consisting of thermoplastic polymers, liquid polymers, elastomers and the mixtures of the latter.

The unsaturated polymer is preferably an elastomer, more preferably a diene elastomer.

It should be remembered that diene elastomer should be understood as meaning an elastomer which results at least in part (i.e. a homopolymer or a copolymer) from diene monomers (monomers bearing two conjugated or non-conjugated carbon-carbon double bonds).

Diene elastomer is understood more particularly to mean:

(a) any homopolymer of a conjugated diene monomer having from 4 to 12 carbon atoms;

(b) any copolymer of a conjugated diene monomer, in particular any copolymer of a conjugated diene monomer and of a monoolefin, such as ethylene or an α-monoolefin, the conjugated diene monomer having from 4 to 12 carbon atoms;

(c) any homopolymer of a non-conjugated diene monomer having from 5 to 12 carbon atoms;

(d) any copolymer of a non-conjugated diene monomer, in particular any copolymer of a non-conjugated diene monomer and of a monoolefin, such as ethylene or an α-monoolefin, the non-conjugated diene monomer having from 5 to 12 carbon atoms;

(e) a mixture of the polymers defined in (a) to (d).

According to a preferred embodiment of the second alternative form of the invention, the unsaturated polymer is a diene elastomer selected from the group consisting of polybutadienes, polyisoprenes, butadiene copolymers, isoprene copolymers and their mixtures.

The molar content of pendant epoxide functional group in the starting polymer of use for the requirements of the synthesis process in accordance with the invention can vary to a great extent and is adjusted according to the properties desired for the polymer in accordance with the invention, in particular according to the use which will be made of it. It is expressed with respect to 100 mol of monomer units constituting the starting polymer. When the molar content of pendant epoxide functional group in the starting polymer is less than 0.1 and when the nucleophilic compound bears a hydroxyaryl group, the maximum molar content of pendant hydroxyaryl group on the polymer in accordance with the invention will be at most 0.1 mol per 100 mol of monomer units, which implies that the targeted technical effect of improving the dispersion of a reinforcing filler within a modified polymer risks being insufficient. This is why the molar content of pendant epoxide functional group in the starting polymer is advantageously at least 0.1. Preferably, it varies within a range extending from 0.1 to 100, more preferably from 0.1 to 80, more preferably still from 0.1 to 50, in particular from 0.1 to 20.

The other essential compound of the synthesis process of the invention is a nucleophilic compound. The nucleophilic compound is a compound bearing both the hydroxyaryl group and a nucleophilic functional group selected from the group consisting of the primary amine functional group, the secondary amine functional group, the carboxylic acid functional group and their ionic form.

According to a preferred embodiment of the invention, the hydroxyaryl group is an aryl group which bears two hydroxyl functional groups directly bonded to the benzene ring, preferably vicinal functional groups. Two vicinal functional groups is understood to mean two functional groups which are borne by carbons of the benzene ring which are adjacent. In other words, one hydroxyl functional group is in the ortho position with respect to the other hydroxyl functional group.

Primary amine functional group is understood to mean the NH₂ group, typically present in a primary amine.

Secondary amine functional group is understood to mean the NH group, typically present in a secondary amine.

Carboxylic acid functional group is understood to mean the COOH group, typically present in a carboxylic acid.

The nucleophilic functional group is capable of reacting with the epoxide functional group of the starting polymer by opening of the epoxide ring. The nucleophilic compound corresponds to the following formula (I):

A-B-X (I)

in which:

A represents a nucleophilic functional group selected from the group consisting of the primary amine functional group, the secondary amine functional group, the carboxylic acid functional group and their ionic form, preferably the carboxylic acid functional group or its ionic form,

B is a “spacer” representing an atom or a group of atoms forming a connection between A and X,

X represents an aryl group bearing from 1 to 5 hydroxyl functional groups directly bonded to the benzene ring, which ring may furthermore be otherwise substituted or unsubstituted.

The B group makes it possible to link together the A group and the X group. The B group can be a linear, branched or cyclic divalent hydrocarbon chain. The said chain can optionally be substituted. The said chain can also comprise at least one heteroatom, provided that it does not then constitute a nucleophilic group which is reactive with regard to the epoxide functional group. Preferably, the B group is a linear or branched C₁-C₂₄, more preferably C₁-C₁₀, hydrocarbon chain, more preferably still a linear C₁-C₆, in particular C₂, alkylene chain.

X can be represented by the following formula (II):

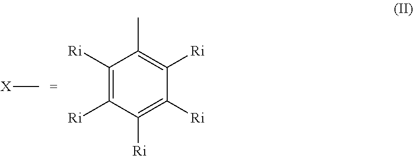

in which the Ri groups, which are identical or different, represent a hydrogen atom or a hydroxyl functional group, at least one of the Ri groups representing a hydroxyl functional group.

According to a preferred embodiment of the invention, the aryl group X is substituted by two hydroxyl functional groups, preferably vicinal functional groups.

According to another embodiment, two Ri groups each represent a hydroxyl functional group, the other Ri groups each representing a hydrogen atom. According to this embodiment, the X group preferably corresponds to the formula (III):

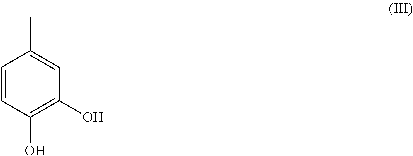

According to particularly advantageous alternative forms of the invention, the nucleophilic compound corresponds to the formula A-B-X for which any one of the following conditions is met:

a) A represents the carboxylic acid functional group or its ionic form,

b) B represents a divalent C₁-C₆ hydrocarbon group,

c) X represents an aryl group substituted on two consecutive carbon atoms by two hydroxyl functional groups.

According to these alternative forms, the nucleophilic compound more preferably corresponds to the formula (IV):

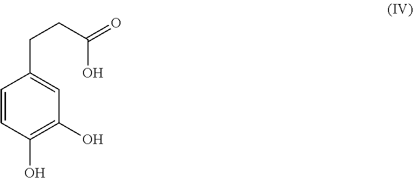 [SMILES: O=C(O)CCc1ccc(O)c(O)c1]

The reaction of the starting polymer with the nucleophilic compound is generally carried out under conventional conditions for epoxide ring opening reactions, in bulk or in solution, in particular at reflux of the solvent of the reaction. Use is generally made of a polar solvent, preferably an ether, such as dioxane.

The introduction of hydroxyaryl group by a postpolymerization reaction onto a polymer bearing at least one pendant epoxide functional group makes it possible to avoid the stages of protection and deprotection which are necessary when copolymerization is carried out starting from a monomer bearing a hydroxyaryl group. In addition, the high yield, which can reach at least 90% of the opening of the epoxide rings, makes possible perfect control of the content of hydroxyaryl group introduced along the chain.

According to a preferred embodiment of the invention, the process in accordance with the invention results in the synthesis of a polymer in accordance with the invention which contains at least one pendant hydroxyaryl group, preferably several pendant hydroxyaryl groups.

Another subject-matter of the invention is the polymer bearing at least one hydroxyaryl group capable of being obtained by the process in accordance with the invention according to any one of its embodiments described above. The polymer in accordance with the invention can be an elastomer, a liquid polymer or a thermoplastic polymer, whether block, alternating or random. Preferably, the polymer in accordance with the invention is an elastomer, better still a diene elastomer.

The polymer in accordance with the invention comprises, on the one hand, a main chain derived from a polymer bearing the pendant epoxide functional group and, on the other hand, at least one side group bearing the hydroxyaryl group, which hydroxyaryl group is connected to the main chain via a divalent group resulting from the reaction of the epoxide functional group with the nucleophilic compound.

According to any one of the embodiments of the invention, the content of pendant hydroxyaryl group in the polymer in accordance with the invention preferably ranges from 0.1 to 100, more preferably from 0.1 to 80, more preferably still from 0.1 to 50 and more particularly from 0.1 to 20 mol per 100 mol of monomer units constituting the polymer in accordance with the invention.

According to any one of the embodiments of the invention, the main chain of the polymer in accordance with the invention preferably contains monomer units selected from the group consisting of ethylene units, α-olefin units, (meth)acrylonitrile units, (meth)acrylate units, vinyl ester of carboxylic acid units, vinyl alcohol units and vinyl ether units. Mention be made, as α-olefin units, of α-monoolefins, such as vinylaromatic compounds, such as styrene, conjugated dienes, such as 1,3-butadiene and isoprene, or non-conjugated dienes.

According to any one of the embodiments of the invention, the polymer in accordance with the invention preferably corresponds to the formula (V):

P[-G]i (V)

in which:
P represents the polymer chain derived from the polymer bearing the pendant epoxide functional group,
G represents the side group bearing the hydroxyaryl group, and
i represents the number of pendant hydroxyaryl groups.

A person skilled in the art will understand that the main chain of the polymer in accordance with the invention can comprise residual pendant epoxide functional groups. The content of these residual pendant epoxide functional groups depends in particular on the stoichiometry of the reactants, in particular on the amount introduced into the reaction medium of nucleophilic compound relative to the molar content of epoxide functional group present on the starting polymer. i depends on the yield of the grafting reaction, on the molar content of epoxide functional groups in the starting polymer, as well as on the amount of nucleophilic compound. It is a number at least equal to 1; it is preferably strictly greater than 1.

According to any one of the embodiments of the invention, G is represented preferably by the formula (VI):

-D-B-X (VI)

in which:

D represents a divalent group resulting from the reaction of the pendant epoxide functional group of the starting polymer with the nucleophilic functional group A of the nucleophilic compound;

A, B and X are as described above.

Thus, D can be the divalent group resulting from the reaction of the pendant epoxide functional group with a nucleophilic functional group selected from the group consisting of the primary amine functional group, the secondary amine functional group, the carboxylic acid functional group and their ionic form, preferably with the carboxylic acid functional group or its ionic form.

Among these alternative forms, D can be the divalent group resulting from the reaction of the epoxide functional group with a nucleophilic functional group selected from the group consisting of the primary amine functional group, the secondary amine functional group, the carboxylic acid functional group and their ionic form, preferably with the carboxylic acid functional group or its ionic form. More particularly, D can be the divalent group resulting from the reaction of the epoxide functional group of a glycidyl ester monomer unit, preferably a glycidyl (meth)acrylate monomer unit, with a nucleophilic functional group selected from the group consisting of the primary amine functional group, the secondary amine functional group, the carboxylic acid functional group and their ionic form, preferably with the carboxylic acid functional group or its ionic form.

The polymers bearing one or more pendant hydroxyaryl groups according to the invention can be used as is or as mixtures with one or more other compounds. The presence of pendant hydroxyaryl groups makes it possible to envisage a use in applications similar to those of modified polymers in general, and polymers bearing hydroxyaryl groups in particular. For example, it is known, in order to optimize the interactions between a diene elastomer and a reinforcing filler within a rubber composition, to modify the nature of the diene elastomers in order to introduce functional groups therein. Thus, the specific structure of the polymer bearing one or more pendant hydroxyaryl groups according to the invention makes it possible to envisage its use in the manufacture of various products based on reinforced rubber when the polymer is a diene elastomer, in particular for the purpose of improving the dispersion of the filler within the elastomer matrix.

Another subject-matter of the invention is thus a rubber composition comprising a reinforcing filler and the polymer in accordance with the invention which is preferably an elastomer, more preferably a diene elastomer.

The diene elastomer bearing one or more pendant hydroxyaryl groups in accordance with the invention is then more particularly selected from polybutadienes, polyisoprenes, butadiene copolymers, isoprene copolymers and their mixtures. Suitable as diene elastomer are, for example, SBRs, BIRs, SIRs, SBIRs, copolymers of butadiene and of (meth)acrylic acid ester, copolymers of isoprene and of (meth)acrylic acid ester, copolymers of butadiene, of styrene and of (meth)acrylic acid ester or copolymers of isoprene, of styrene and of (meth)acrylic acid ester.

The rubber composition in accordance with the invention has the characteristic of comprising a reinforcing filler, for example carbon black, a reinforcing filler other than carbon black, in particular of siliceous type, such as silica, with which is combined, in a known way, a coupling agent, or also a mixture of these two types of filler.

According to alternative forms of the invention, the composition can, besides the polymer in accordance with the invention, comprise at least one conventional diene elastomer.

More particularly suitable as conventional diene elastomer are natural rubber, polybutadienes (BRs), butadiene copolymers, polyisoprenes (IRs), isoprene copolymers and the mixtures of these elastomers. Such copolymers are more preferably selected from the group consisting of copolymers of butadiene and of a vinylaromatic monomer, more particularly the butadiene/styrene copolymer (SBR), isoprene/butadiene copolymers (BIRs), copolymers of isoprene and of a vinylaromatic monomer, more particularly the isoprene/styrene copolymer (SIR), and isoprene/butadiene/styrene copolymers (SBIRs).

The conventional diene elastomer can be star-branched, coupled, functionalized or non-functionalized, in a way known per se, by means of functionalization agents, coupling agents or star-branching agents known to a person skilled in the art.

The rubber compositions in accordance with the invention can also comprise all or a portion of the normal additives generally used in elastomer compositions intended for the manufacture of tires, such as, for example, pigments, protective agents, anti-fatigue agents, plasticizers, reinforcing resins, methylene donors (for example HMT or H3M), a crosslinking system and the mixtures of such compounds.

The use of such a rubber composition is particularly appropriate in the field of tires, in particular for vehicles. This is why a tire, one of the constituent elements of which comprises a rubber composition based on a diene elastomer bearing one or more pendant hydroxyaryl groups in accordance with the invention, also constitutes a subject-matter of the invention.

The abovementioned characteristics of the present invention, and also others, will be better understood on reading the following description of several implementational examples of the invention, given by way of illustration and without limitation.

### EXAMPLES

1—Measurements Used:

1.1—Nuclear Magnetic Resonance (NMR):

Copolymers synthesized in emulsion:

The contents of the different monomer units and their microstructures within the copolymer are determined by an NMR analysis. The spectra are acquired on a Bruker 500 MHz spectrometer equipped with a 5 mm BBI Z-grad “broad band” probe. The quantitative ¹H NMR experiment uses a simple 30° pulse sequence and a repetition time of 3 seconds between each acquisition. The samples are dissolved in deuterated chloroform (CDCl₃) or deuterated methanol (MeOD).

Copolymers synthesized in solution:

The ¹H NMR analyses are carried out with a Bruker Avance 300 (300 MHz) spectrometer, QNP ¹H, ³¹P, ¹⁹F and ¹³C probe. The samples are dissolved in deuterated chloroform (CDCl₃).

1.2—Size Exclusion Chromatography (SEC):

Copolymers synthesized in emulsion:

Size exclusion chromatography or SEC is used. SEC makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standards and the polymolecularity or polydispersity index (PI=Mw/Mn) can be calculated via a “Moore” calibration.

Preparation of the polymer: There is no specific treatment of the polymer sample before analysis. The latter is simply dissolved, in tetrahydrofuran+1 vol % of diisopropylamine+1 vol % of triethylamine+0.1 vol % of distilled water, at a concentration of approximately 1 g/l. The solution is then filtered through a filter with a porosity of 0.45 μm before injection.

SEC analysis: The apparatus used is a “Waters Alliance” chromatograph. The elution solvent is tetrahydrofuran+1 vol % of diisopropylamine+1 vol % of triethylamine according to the solvent used for the dissolution of the polymer. The flow rate is 0.7 ml/min, the temperature of the system is 35° C. and the analytical time is 90 min. A set of four Waters columns in series, with commercial names “Styragel HMW7”, “Styragel HMW6E” and two “Styragel HT6E”, is used. The volume of the solution of the polymer sample injected is 100 μl. The detector is a Waters 2410 differential refractometer and the software for making use of the chromatographic data is the Waters Empower system.

The calculated average molar masses are relative to a calibration curve produced from PSS Ready Cal-Kit commercial polystyrene standards.

Copolymers synthesized in solution:

The GPC analyses are carried out on a Varian PL-GPC 50 with RI detector and PolyPore column system. Flow rate: 1 ml/min; Solvent: THF; Temperature: 35° C.

2—Preparation of Polymers Bearing Pendant Epoxide Functional Groups:

### Example 1: Isoprene/Glycidyl Methacrylate (GMA) Radical Solution Copolymerization

30 g of glycidyl methacrylate, 129 g of isoprene, 100 g of toluene and 3.67 g of azobisisobutyronitrile (AIBN) are introduced under a stream of argon into an autoclave reactor. The reaction mixture is heated and stirred at 70° C. overnight. At the end of polymerization, the copolymer is precipitated from methanol. The final product is a viscous polymer obtained with a yield of 60%. It is analysed by ¹H NMR.

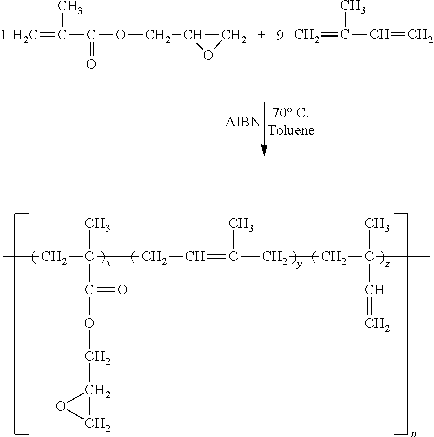

The ¹H NMR spectrum makes it possible to quantify the microstructure within the copolymer by integration of the broad unresolved peaks with signals characteristic of the protons 1 to 5 which appear in the form of broad unresolved peaks. The figure below, which describes the 3 constituent subunits of the polymer, indicates the protons numbered 1 to 5.

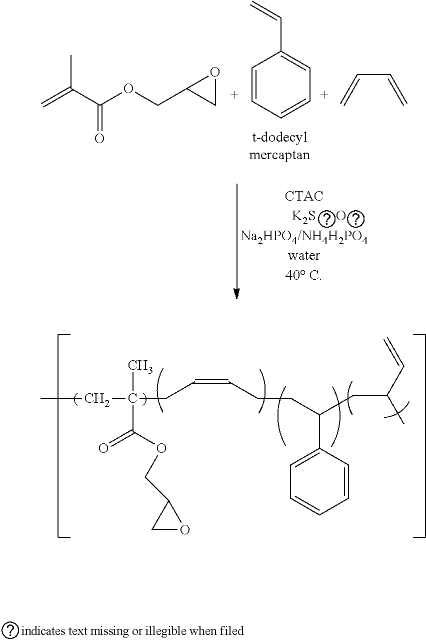

| [symbol] | [symbol] | [symbol] |
|---|---|---|
| [symbol] | [symbol] | [symbol] |
| [symbol] | [symbol] | [symbol] |
| H2 | 3.23 | 1 |
| H1 | 3.8-3.95 | 1 |
| H1 | 4.3-4.5 | 1 |
| H4 H5 | 4.65-5.35 | 3 |

[symbol]

indicates data missing or illegible when filed

The functionality of the copolymer is determined by ¹H NMR assaying with an internal standard. There are 1.58 milliequivalents (meq) of epoxide functional group per gram of product.

The molar mass is evaluated by SEC with polystyrene calibration:

Mn=6 000 g/mol; Mw=16 900 g/mol; PI=2.8

There are thus approximately 9.5 epoxide functional groups per chain. The composition of the copolymer is as follows: 12 mol % of glycidyl methacrylate and 88 mol % of isoprene.

### Example 2: Styrene/Butadiene/GMA Radical Emulsion Copolymerization

Radical emulsion polymerization is carried out in a capped bottle with moderate stirring and under an inert nitrogen atmosphere.

0.120 g of K₂S₂O₈ and 0.5 g of hexadecyltrimethylammonium chloride are introduced into a bottle. The bottle is capped and then sparged with nitrogen for 10 min. The following compounds and solutions (these solutions having been sparged beforehand to remove any trace of oxygen) are subsequently successively introduced into the bottle.
90 ml of water
4.5 ml of a 100 g/l Na₂HPO₄ solution
1.9 ml of a 100 g/l NH₄H₂PO₄ solution
444 μl of a 0.7 mol/l solution of tert-dodecyl mercaptan in styrene
2.1 ml of styrene
1.9 ml of glycidyl methacrylate
9.4 ml of butadiene

The reaction medium is stirred and heated at 40° C. The polymerization is halted after 60% conversion by the addition of 1 ml of a 100 g/l solution of resorcinol in water.

The copolymer is precipitated from an acetone/methanol (50/50 v/v) mixture.

The copolymer is dried by placing in an oven under vacuum (200 torr) at 50° C. for 1 day. The copolymer is analysed by ¹H NMR.

The ¹H NMR spectrum makes it possible to quantify the microstructure within the copolymer by integration of the broad unresolved peaks with signals characteristic of the protons 1 to 12 which appear in the form of broad unresolved peaks. The figure below, which describes the 4 constituent subunits of the polymer, indicates the protons numbered 1 to 12.

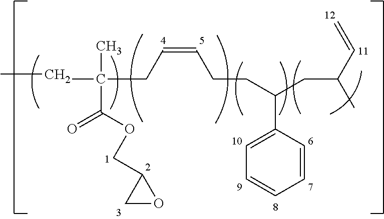

| Proton No. | Chemical shift (ppm) | Number of protons |
|---|---|---|
| H3 | 2.56-2.75 | 2 |
| H2 | 3.11 | 1 |
| H1 | 3.34-4.35 | 2 |
| H12 | 4.6-4.9 | 2 |
| H4 H5 H11 | 4.9-5.5 | 3 |
| H6 H7H8 H9 H10 | 6.8-7.2 | 5 |

The distribution of the monomer units of the copolymer is given below, that of the butadiene units being given according to the 1,2 and 1,4 subunits of the polybutadiene part (respectively PB1-2 and PB1-4):

| | mol % |
|---|---|
| % Styrene | 11.5% +/− 1.5 |
| % PB1-2 | 12% +/− 0.5 |
| % PB1-4 | 66% +/− 0.5 |
| % glycidyl methacrylate | 10.5% +/− 0.5 |

The polymer is analysed by SEC: Mn=47 070 g/mol, PI=1.86

3—Preparation of Polymers Bearing Pendant Hydroxyaryl Groups:

### Example 3

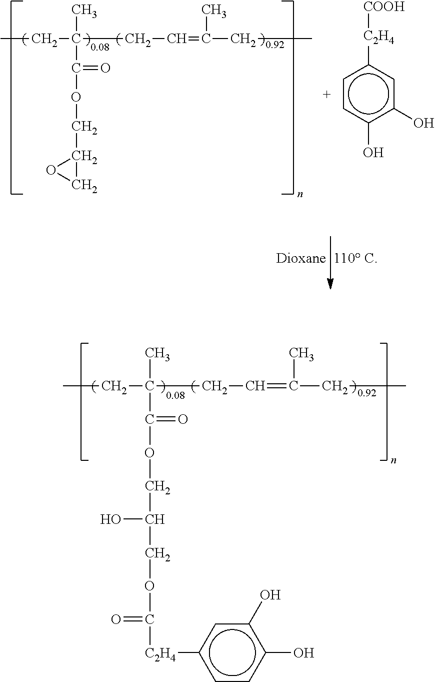

50 g of isoprene/glycidyl methacrylate copolymer resulting from Example 1 are dissolved in 200 ml of dioxane in a three-necked round-bottomed flask surmounted by a reflux condenser. 16.07 g of 3,4-dihydroxyhydrocinnamic acid are added. The reaction medium is then stirred under mechanical stirring and heated at 105° C. under an inert atmosphere for 72 h.

The reaction medium is subsequently allowed to return to ambient temperature under an inert atmosphere and then the polymer is coagulated from water, filtered off and then redissolved in dichloromethane in order to be dried over Na₂SO₄. The solution is finally evaporated to dryness to provide a viscous liquid with a yield of 95%.

The functional polymer is analysed by ¹H NMR.

The ¹H NMR spectrum makes it possible to quantify the microstructure within the copolymer by integration of the broad unresolved peaks with signals characteristic of the protons 1 to 8 which appear in the form of broad unresolved peaks. The figure below, which describes the 3 constituent subunits of the polymer, indicates the protons numbered 1 to 8.

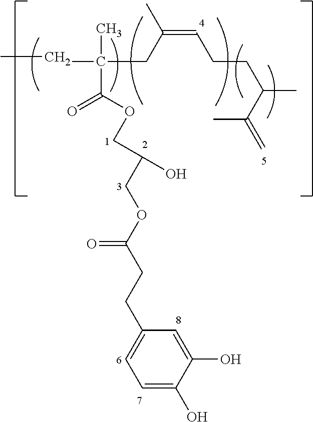

| Proton No. | Chemical shift (ppm) | Number of protons |
|---|---|---|
| H1, H2, H3 | 3.40-4.5 | 5 |
| H4 H5 | 4.6-5.4 | 3 |
| H6, H7, H8 | 6.4-6.9 | 3 |

The functionality of the copolymer is determined by ¹H NMR assaying with an internal standard. There are 1.03 milliequivalents of catechol per gram of product.

The molar mass is evaluated by SEC: Mn=7800 g/mol; Mw=30 800 g/mol; PI=3.9 There are approximately 8 catechol functional groups per chain.

### Example 4

1.5 g of styrene/butadiene/glycidyl methacrylate copolymer resulting from Example 2 are dissolved in 15 ml of dioxane in a three-necked round-bottomed flask surmounted by a reflux condenser. 0.39 g of 3,4-dihydroxyhydrocinnamic acid (1 equivalent with respect to the number of moles of epoxide functional groups) is added. The reaction medium is then stirred under mechanical stirring and heated at 105° C. under an inert atmosphere for 72 h. The reaction medium is subsequently allowed to return to ambient temperature under an inert atmosphere and then the polymer is coagulated from water and dried by placing in an oven under vacuum (200 torr) at 60° C. for 1 day.

The functional polymer is analysed by ¹H NMR:

The ¹H NMR spectrum makes it possible to quantify the microstructure within the copolymer by integration of the broad unresolved peaks with signals characteristic of the protons 1 to 15 which appear in the form of broad unresolved peaks. The figure below, which describes the 3 constituent subunits of the polymer, indicates the protons numbered 1 to 15.

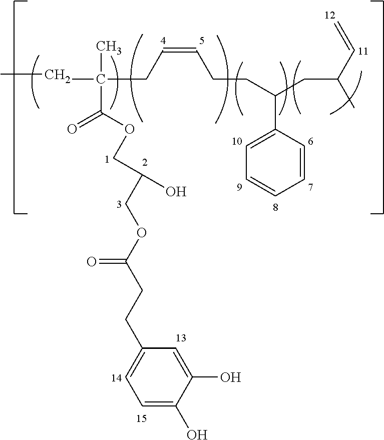

| Proton No. | Chemical shift (ppm) | Number of protons |
|---|---|---|
| H1, H2, H3 | 3.34-4.35 | 5 |
| H12 | 4.6-4.9 | 2 |
| H4 H5 H11 | 4.9-5.5 | 3 |
| H13, H14, H15 | 6.3-6.7 | 3 |
| H6 H7H8 H9 H10 | 6.8-7.2 | 5 |

The distribution of the monomer units of the copolymer is given below, that of the butadiene units being given according to the 1,2 and 1,4 subunits of the polybutadiene part (respectively PB1-2 and PB1-4):

| | mol % |
|---|---|
| % Styrene | 11% +/− 1.5 |
| % PB1-2 | 14% +/− 0.5 |
| % PB1-4 | 64% +/− 0.5 |
| % glycidyl methacrylate | 11% +/− 0.5 |
| opened with the 3,4- | |
| dihydroxyhydrocinnamic | |
| acid | |

The polymer is analysed by SEC: Mn=40 380 g/mol; PI=2.37

Whether it concerns Example 3 or Example 4, it is noted that the epoxide functional groups of the glycidyl groups present on the copolymer have reacted quantitatively with the nucleophilic compound, the dihydroxyhydrocirmamic acid.

To sum up, a copolymer having pendant hydroxyaryl groups is obtained, with good control of the number of pendant hydroxyaryl groups, according to a simple process.

1. A process for the synthesis of a polymer bearing at least one pendant hydroxyaryl group, which process comprises the reaction of a starting polymer bearing at least one pendant epoxide functional group with a nucleophilic compound simultaneously bearing the hydroxyaryl group and bearing a nucleophilic functional group selected from the group consisting of the primary amine functional group, the secondary amine functional group, the carboxylic acid functional group and their ionic form.

2. A process according to claim 1, in which the hydroxyaryl group is an aryl group which bears two hydroxyl functional groups directly bonded to the benzene ring.

3. A process according to claim 1, in which the nucleophilic compound corresponds to the following formula (I):
A-B-X (I)
in which:
A represents the nucleophilic functional group selected from the group consisting of the primary amine functional group, the secondary amine functional group, the carboxylic acid functional group and their ionic form,
B is a “spacer” representing an atom or a group of atoms forming a connection between A and X,
X represents an aryl group bearing from 1 to 5 hydroxyl functional groups directly bonded to the benzene ring.

4. A process according to claim 3, in which A represents the carboxylic acid functional group or its ionic form in the formula (I).

5. A process according to claim 3, in which X represents, in the formula (I): 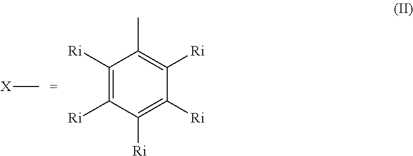
in which the Ri groups, which are identical or different, represent a hydrogen atom or a hydroxyl functional group, at least one of the Ri groups representing a hydroxyl functional group.

6. A process according to claim 3, in which any one of the following conditions is met in the formula (I):
A represents the carboxylic acid functional group or its ionic form,
B represents a divalent C₁-C₆ hydrocarbon group,
X represents an aryl group substituted on two neighbouring carbon atoms by two hydroxyl functional groups.

7. A process according to claim 3, in which X represents, in the formula (I):

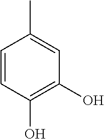

8. A process according to claim 1 in which the nucleophilic compound corresponds to the formula:

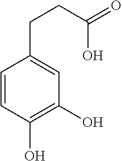 [SMILES: O=C(O)CCc1ccc(O)c(O)c1]

9. A process according to claim 1, in which the starting polymer is a polymer of at least one first monomer bearing the epoxide functional group.

10. A process according to claim 1, in which the starting polymer is a polymer of at least one first monomer bearing the epoxide functional group and of at least one second monomer.

11. A process according to claim 10, in which the second monomer is a vinyl monomer selected from:
ethylene,
α-olefins,
(meth)acrylonitrile,
(meth)acrylates,
vinyl esters of carboxylic acids,
vinyl alcohol,
vinyl ethers,
and the mixtures of these monomers.

12. A process according to claim 10, in which the second monomer is ethylene.

13. A process according to claim 10, in which the second monomer is an α-monoolefin, a conjugated diene or a non-conjugated diene.

14. A process according to claim 13, in which the second monomer is 1,3-butadiene, isoprene or their mixture.

15. A process according to claim 13, in which the second monomer is styrene.

16. A process according to claim 1, in which the starting polymer is a polymer of at least one first monomer bearing the epoxide functional group, of ethylene or of an α-olefin and of a third monomer, which third monomer is a vinyl monomer selected from:
ethylene,
α-olefins
(meth)acrylonitrile,
(meth)acrylates,
vinyl esters of carboxylic acids,
vinyl alcohol,
vinyl ethers,
and the mixtures of these monomers.

17. A process according to claim 9, in which the first monomer bearing the epoxide functional group bears an epoxide functional group.

18. A process according to claim 17, in which the first monomer bearing a glycidyl group is a glycidyl ester of an α,β-unsaturated carboxylic acid.

19. A process according to claim 1, in which the starting polymer is obtained by postpolymerization modification of an unsaturated polymer with an epoxidized compound.

20. A process according to claim 19, in which the unsaturated polymer is one of the diene elastomers (a) to (e):
(a) a homopolymer of a conjugated diene monomer having from 4 to 12 carbon atoms,
(b) a copolymer of a conjugated diene monomer having from 4 to 12 carbon atoms,
(c) a homopolymer of a non-conjugated diene monomer having from 5 to 12 carbon atoms,
(d) a copolymer of a non-conjugated diene monomer having from 5 to 12 carbon atoms,
(e) a mixture of the polymers defined in (a) to (d).

21. A process according to claim 19, in which the unsaturated polymer is a diene elastomer selected from the group consisting of polybutadienes, polyisoprenes, butadiene copolymers, isoprene copolymers and their mixtures.

22. A process according to claim 1 in which the starting polymer is an elastomer.

23. A process according to claim 1, in which the content of pendant epoxide functional group in the starting polymer is at least 0.1 mol per 100 mol of monomer units constituting the starting polymer.

24. A polymer bearing at least one pendant hydroxyaryl group capable of being obtained by the process defined according to claim 1.

25. A polymer according to claim 24, which the polymer is an elastomer.

26. A rubber composition based on at least one reinforcing filler and a polymer defined according to claim 24.

27. A tire which comprises a rubber composition according to claim 26.

28. A process according to claim 18 in which the first monomer bearing a glycidyl group is glycidyl methacrylate, glycidyl acrylate or glycidyl itaconate.
